(19) United States
(12) Patent Application Publication
(10) Pub. No.: US 2012/0048943 A1
(43) Pub. Date: Mar. 1, 2012

(54) CHIP CARD AND PORTABLE ELECTRONIC DEVICE USING THE SAME

(75) Inventor: TE-FENG LIN, Tu-Cheng (TW)

(73) Assignee: CHI MEI COMMUNICATION SYSTEMS, INC., Tu-Cheng City (TW)

(21) Appl. No.: 12/909,967

(22) Filed: Oct. 22, 2010

(30) Foreign Application Priority Data
Aug. 30, 2010 (TW) 99129168

(51) Int. Cl. G06K 19/077

(52) U.S. Cl. 235/492

(57) ABSTRACT

A chip card includes a card portion and a chip. The chip is detachably assembled in the card portion. When the chip is assembled in the card portion, the chip card can be used at an ATM or a POS device. When the chip is disassembled from the card portion, the chip can be mounted in a portable electronic device and used with the portable electronic device.

### BACKGROUND

1. Technical Field

The disclosure generally relates to chip cards such as automatic teller machine (ATM)/debit/credit cards, particularly to a chip card that can be used with devices other than an ATM or a point of sale (POS) device.

2. Description of Related Art

ATM/debit/credit Chip cards are widely used in everyday life. Users can deal with many types of transactions such as payments, checking account information, and transferring money to other accounts at an ATM or a POS device with their chip cards. However, these transactions can only be done at the ATM or the POS device which may be inconvenient.

Therefore, there is room for improvement within the art.

### BRIEF DESCRIPTION OF THE DRAWINGS

Many aspects of the chip card and portable electronic device using the same can be better understood with reference to the following drawings. The components in the drawings are not necessarily drawn to scale, the emphasis instead being placed upon clearly illustrating the principles of the chip card and portable electronic device using the same.

FIG. 1 is a schematic view of a chip card, according to an exemplary embodiment.

FIG. 2 is a disassembled view of the chip card of FIG. 1.

FIG. 3 is a schematic view with a chip of the chip card of the FIG. 1 assembled in the portable electronic device, according to an exemplary embodiment.

### DETAILED DESCRIPTION

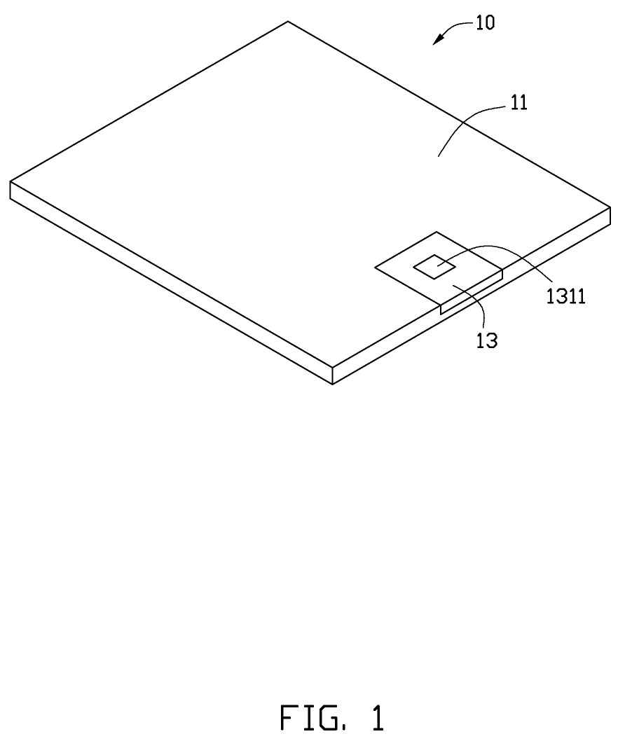

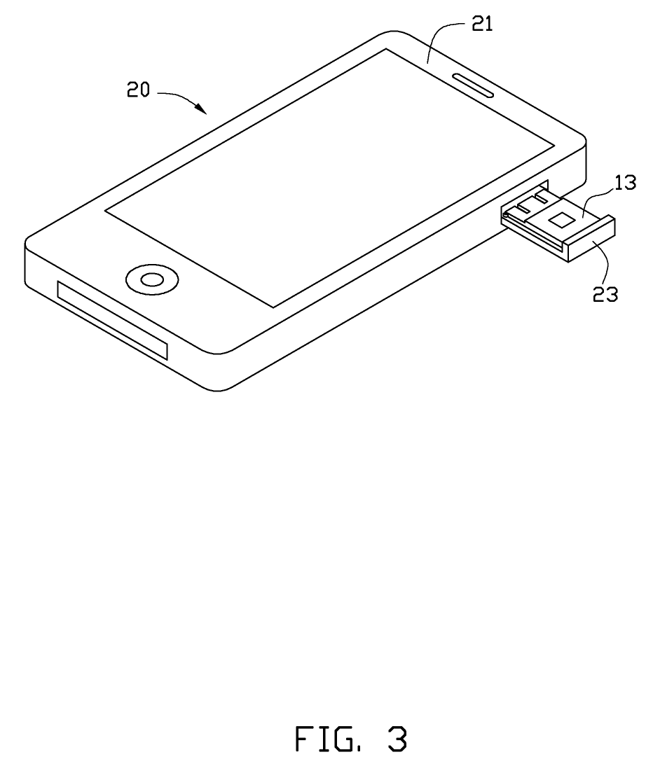

FIG. 1 shows a chip card 10 that can be used with a chip card reader, such as an ATM or POS device or in a portable electronic device to perform bank transactions and enquiries, according to an exemplary embodiment. The chip card 10 includes a card portion 11 and a chip 13 detachably assembled to the card portion 11. When the chip 13 is assembled to the card portion 11, the chip card 10 can be used with the chip card reader, such as the ATM or POS device. When the chip 13 is disassembled from the card portion 11, the chip 13 can be mounted in a chip reader of a portable electronic device 20 (shown in FIG. 3), such as a mobile phone and used to perform the bank transactions and enquiries that do not involve the physical exchange of money and receipts.

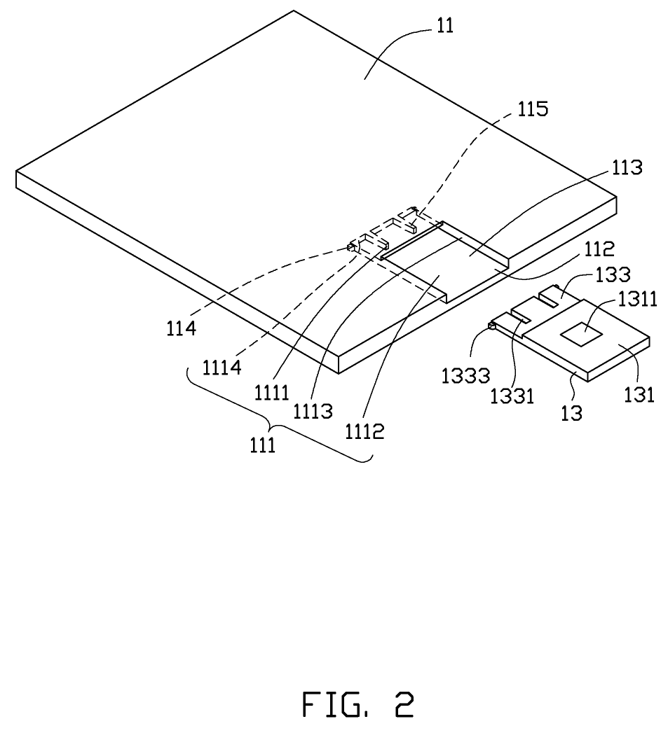

Referring to FIG. 2, the card portion 11 is substantially rectangular. The card portion 11 includes a chip chamber 111 having an open end 112. The chip chamber 111 includes an upper portion 1111, a bottom portion 1112 opposite to the upper portion 1111, two opposite side portions 1113 connected the upper portion 1111 and the bottom portion 1112, and an end portion 1114 connected to the upper portion 1111, the bottom portion 1112, and the two side portion 1113. An opening 113 is defined in the upper portion 1111 of the chip chamber 111 communicating with the open end 112. Two opposite latching holes 114 are respectively defined in each side portion 1113 adjacent to the end portion 1114. Two positioning posts 115 protrude from the end portion 1114.

The chip 13 includes a chip portion 131 and a latching portion 133. The chip portion 131 includes a contact portion 1311. The chip portion 131 stores bank account information. When the chip card 10 is inserted into an ATM or swiped by a POS device, the contact portion 1311 connects to the ATM or the POS device, and the account information can be read by the ATM and the POS device. The latching potion 133 is substantially a sheet extending from one side of the chip portion 131. Two positioning slots 1331 are defined in the latching portion 133 corresponding to the positioning posts 119. Two opposite latching protrusions 1333 protrude from each side of the latching portion 1333 corresponding to the latching holes 114.

To use the chip card 10 at the ATM or the POS device, the chip 13 is inserted into the chip chamber 111 from the open end 112. The two positioning posts 115 are received in the corresponding positioning slots 1131. The two protrusions 1333 engage with the corresponding latching holes 114 to prevent the chip 13 separating from the card portion 11. The chip 13 is received in the chip chamber 111 with the chip portion 13 coplanar with the upper portion 111, and forms the complete chip card 10. The chip 13 can communicate with the ATM or the POS device by the exposed contact portion 1311 when the chip card 10 is inserted into the ATM or swiped by the POS device.

Referring to FIG. 3, the portable electronic device 20 includes a main body 21. The main body 21 includes a drawer 23 slideably positioned in one side thereof. To use the chip card 10 in the portable electronic device 20, the chip 13 is disassembled from the card portion 11. The chip 13 can be placed in the drawer 23 and the drawer 23 slid into the main body 21. When the chip 13 is received in the main body 21, the chip 13 communicates with the portable electronic device 20 by the contact portion 1311. Therefore, cashless and paperless banking transactions and enquiries can be performed with the portable electronic device 20.

The chip card 10 can be used at the ATM, the POS device or the portable electronic device 20. Therefore, depending on the nature of the banking transactions and enquiries, users can freely and conveniently choose the ATM, the POS device or the portable electronic device 20.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A chip card; comprising:
a card portion; and
a chip detachably assembled in the card portion; wherein when the chip is assembled in the card portion, the chip card can be used with a chip card reader; when the chip is disassembled from the card portion, the chip can be mounted in a portable electronic device and used by the portable electronic device.

2. The chip card of claim 1, wherein the chip card reader comprises an ATM or a POS device

3. The chip card as claimed in claim 1, wherein the card portion includes a chip chamber having an open end, the chip can be inserted into the chamber from the open end and received in the chamber.

4. The chip card as claimed in claim 3, wherein the chip chamber includes an upper portion, a bottom portion opposite to the upper portion, two opposite side portions connected the upper portion and the bottom portion, and an end portion connected to the upper portion, the bottom portion and the two side portions; at least one of the side portions defines at least one latching hole to latch the chip.

5. The chip card as claimed in claim 4, wherein the chip includes a chip portion and a latching portion extending from one side of the chip portion, at least one latching protrusion protrudes from one the latching portion, the latching protrusion engages with the latching hole when the chip is received in the chip chamber.

6. The chip card as claimed in claim 4, wherein the latching portion further defines at least one positioning slot, the at least one positioning post protrudes from the end portion corresponding to the positioning slot, the positioning post is received in the positioning slot when the chip is received in the chip chamber.

7. The chip card as claimed in claim 5, wherein the upper portion defines an opening communicating with the opening end, the chip portion includes a contact portion, the contact portion is exposed from the opening when the chip is received in the chip chamber.

8. The chip card as claimed in claim 6, wherein the upper portion is coplanar with the chip portion when the he chip is received in the chip chamber.

9. A portable electronic device, comprising:
a main body including a card drawer slideably positioned at one side thereof, and
a chip placed in the card drawer and receivable in the main body; wherein when the chip is disassembled from the portable electronic device, the chip can be received in a card portion to form an chip card, and the chip card can be used with a chip card reader.

10. The portable electronic device of claim 9, wherein the chip card reader comprises an ATM or a POS device.

11. The portable electronic device as claimed in claim 9, wherein the chip includes a contact portion, the chip can communicate with the main body by the contact portion.

12. The portable electronic device as claimed in claim 9, wherein the chip is portion of an chip card and stores bank account information.
